(19) United States
(12) Patent Application Publication
(10) Pub. No.: US 2025/0206996 A1
(43) Pub. Date: Jun. 26, 2025

(54) POWDER COATING COMPOSITION AND ADHESIVE CONNECTION

(71) Applicant: Pulver Kimya San. Ve Tic A.S., Gebze (TR)

(72) Inventors: Martin Michael WITTIG, Darmstadt (DE); Hüseyin Çagatay PAKKAN, Istanbul (TR)

(73) Assignee: Pulver Kimya San. Ve Tic A.S., Gebze (TR)

(21) Appl. No.: 19/080,014

(22) Filed: Mar. 14, 2025

Related U.S. Application Data
(63) Continuation of application No. PCT/EP2023/075149, filed on Sep. 13, 2023.

(30) Foreign Application Priority Data
Sep. 14, 2022 (EP) 22195582.6

(51) Int. Cl. C09J 9/00; C08K 3/22; C08K 3/34; C09D 5/00; C09D 5/03; C09D 7/40; C09D 7/61; C09D 11/54; C09J 11/04

(52) U.S. Cl. CPC C09J 9/00; C09D 5/002; C09D 5/031; C09D 7/61; C09D 7/69; C09D 11/54; C09J 11/04; C08K 2003/2227; C08K 2003/343; C08K 2201/005

(57) ABSTRACT

A powder coating composition for promoting adhesion consists of: an extruded and subsequently ground mixture of binding agents, hardening agents and optionally one or more of pigments, filler and additives; and porous particles of a mesoporous or microporous material in a proportion of one to twelve percent by weight of the powder coating composition. An adhesive connection of at least two joining parts having an adhesion promoting layer between the joining parts is also provided.

### CROSS-REFERENCE TO RELATED APPLICATIONS

This application is a continuation of International Application No. PCT/EP2023/075149, filed on Sep. 13, 2023, which claims priority to and the benefit of EP 22195582.6, filed on Sep. 14, 2022. The disclosures of the above applications are incorporated herein by reference.

### FIELD

The present disclosure relates to a powder coating composition for promoting adhesion.

### BACKGROUND

The statements in this section merely provide background information related to the present disclosure and may not constitute prior art.

U.S. Pat. No. 6,592,937 B1 discloses adhesion of a thermosetting powder coating to a glass substrate surface using a silane adhesion promoter, enhanced by modifying the pH of the glass surface to between 3.5 and 5, prior to, or during, the action of the promoter. The pH-modification may be effected during washing of the surface prior to spray-application of the promoter, or by including an acid or alkali modifier in the silane solution. Alternatively, the silane, or the silane and the modifier, may be included in the thermosetting powder to become active during fusing of the powder to the glass surface. An acid or alkali solution dried on the surface prior to application of the promoter for activation with the promoter on heating, may be used instead or in addition.

### SUMMARY

This section provides a general summary of the disclosure and is not a comprehensive disclosure of its full scope or all of its features.

It is an objective to provide a powder coating composition with enhanced adhesion promoting capability of a coating made with the powder coating composition.

According to an aspect, the objective is achieved by a powder coating composition according to claim 1. The powder coating composition for promoting adhesion consists of an extruded and subsequently ground mixture of at least one binding agent, at least one hardening agent and optionally one or more of pigments, filler and additives, and porous particles of a mesoporous or microporous material in a proportion of one to twelve percent by weight of the powder coating composition, wherein the porous particles have an average particle size of one micrometer to 200 micrometers.

The particles of a mesoporous or microporous material impart improved adhesion promoting properties of a coating made with the powder coating composition. The particle size is the length of the particle in its main direction of extension, or its diameter if no main direction of extension exists. A maximum particle size of the mesoporous or microporous material can be about three times the average particle size. The mesoporous or microporous material is a material containing pores or voids of a certain porosity and/or medium diameter of its pores.

For bulk materials like the particles of a mesoporous or microporous material with particles ranging from one micrometer (μm) to 200 micrometers (μm) in average particle size, several particle size measurement methods can be considered by the skilled person, including the common methods of laser diffraction, sieve analysis and Coulter Counter (Electrical Sensing Zone). Laser diffraction is a widely used method for particle size analysis. It works well for particles within the specified size range. This technique measures the angular variation in light scattering as particles pass through a laser beam. The resulting data can be used to calculate particle size distribution. Sieve analysis is a traditional method used for particles larger than about 45 micrometers. It involves passing the bulk material through a series of stacked sieves with progressively smaller openings. Particles are separated based on size, and the weight or mass retained on each sieve is used to determine the particle size distribution. The Coulter Counter method measures the changes in electrical impedance as particles pass through a small aperture. It is suitable for sizing and counting particles in the micrometer size range. Further known methods are optical microscopy or electron microscopy, which can be used for visual inspection and sizing of individual particles. This method is particularly useful when precise sizing or characterization of specific particles is needed, but is less practical for bulk analysis. Another method, the dynamic light scattering (DLS), also known as photon correlation spectroscopy (PCS), is rather suitable for measuring the size of smaller particles in the nanometer to micrometer range. It may be used for the smaller particles of the ground mixture but rather not for the mesoporous or microporous material. DLS measures fluctuations in the intensity of scattered light caused by Brownian motion of particles. The skilled person choses the particle size measurement method depending on factors such as the size range of interest, the nature of the material, the required accuracy, and the available equipment. In many cases, a combination of methods may be used to obtain a comprehensive understanding of the particle size distribution in the mesoporous or microporous material.

The binding agent or binder of a powder coating composition is known to the person skilled in the art as substance that hardens by a chemical process to bind other components of the powder coating composition. The binding agent can comprise, for example, at least one of a group of epoxy resin, polyester resin and phenolic resin. The hardening agent or curing agent of a powder coating composition is known to the person skilled in the art to crosslink and cure the binding agent to harden the powder coating by facilitating the bonding of molecular components of the powder coating. The choice of the hardening agent depends on the binding agent being used. For an epoxy resin, the hardening agent can comprise, at least one of a group of acidic polyester resin, dicyandiamide (DICY), polyamide and anhydrides like hexahydrophthalic anhydride. For a polyester resin, the hardening agent can comprise, at least one of a group of TGIC (Triglycidyl Isocyanurate), HAA (Hydroxyalkyl amides) and isophorone diisocyanate (IPDI). For a phenolic resin, the hardening agent can comprise, at least one of a group of hexamethylenetetramine (HMTA) and P-tert-Butylphenol-formaldehyde resin. The respective hardening agent is known to react with its corresponding binding agent resin when exposed to heat during a curing process, creating a crosslinked network that provides the desired properties for the powder coating. The combination of a plurality of binding agents and hardening agents is common knowledge for the person skilled in the art.

According to embodiments, the porous particles can have an average particle size of one micrometer to 50 micrometers. An average particle size of one micrometer to ten micrometers and a maximum particle size of 20 micrometers to 30 micrometers advantageously provides a smooth surface of the coating made with the powder coating composition.

According to a further embodiment, the porous particles may be blended into the previously ground mixture. The porous particles are neither extruded with the ingredients of the ground mixture nor are the porous particles ground. The adhesion promoting properties imparted by the porous particles is enhanced by not processing them together with the other ingredients of the mixture. The porous particles can be bonded to nonporous particles of the ground mixture. Nonporous particles refer to the ingredients of the mixture that are extruded and subsequently ground. An application behavior can be improved by bonding the porous particles. By bonding, a segregation of the porous particles from the nonporous particles is reduced. Further, bonded powder compositions have better processability and stability than non-bonded powder compositions, especially in continuous application systems with powder circulation. The porous particles bonded to the nonporous powder matrix results in a significantly improved adhesion promotion of the resulting coating.

For example, the porous particles are bonded in a mixer to the nonporous particles of the ground mixture. The powder coating composition is generally prepared by mixing the nonporous constituents and homogenizing the melted mixture in the extruder. Subsequently, solid lumps of extruded nonporous ingredients are ground to the desired nonporous particle size. Advantageously, a destruction of the porous particles can be prevented by admixing it to the nonporous particles after grinding, which is also called dry-blending. The powder coating composition may segregate. The effect of segregation can advantageously be reduced by the bonding process, wherein a uniform adhesion of the porous particles to surfaces of the nonporous particles is achieved. By heating the nonporous particles to almost glass-transition temperature, the porous particles are bonded to the sticky nonporous particles, thus reducing the segregation.

The mesoporous material, for example, has pores with diameters between 2 and 50 nanometers. In this context, mesoporosity refers to a classification of nanoscale porosity. The porous particles can be of microporous material, having pores with diameters less than 2 nanometers. Examples of microporous materials include zeolites and metal-organic frameworks. According to further embodiments, the porous particles may be of diatomaceous earth or another natural or synthetic microporous material, such as a zeolite or active alumina.

The powder coating composition is a solvent-free and environment-friendly composition, which may be applied electrostatically to a substrate, on which it may be cured by baking or by radiative energy to form a coating. Fluidized bed sintering is also a known powder coating process, wherein the powder coating composition is applied uniformly to a preheated surface by means of a fluidized bed.

According to a further embodiment, the proportion of the porous particles can be three to ten percent by weight of the powder coating composition, in particular the proportion of the porous particles can be five to seven percent by weight of the powder coating composition.

The optional pigments can be titanium dioxide, the optional filler may be one or more of calcium carbonate, talc and barium sulfate, and the optional additives can be a levelling agent, the levelling agent being one of a silicone-based agent like polydimethylsiloxane modified-PDMS, an acrylate-based agent like polyacrylate, a fluorocarbon-based agent like modified fluorocarbon and a hydrocarbon-based levelling agent, and/or a degassing agent, such as benzoin or wax. While benzoin is the most commonly used degassing agent, in certain applications further degassing agents like wax are used. The levelling agent is known to the skilled person as a chemical substance added to a coating to enhance its thickness uniformity when applied to a surface. Benzoin is known to the skilled person as a commonly used degassing agent in powder coatings. It is used to eliminate the problems of pinholes, shrinkage holes and bubbles during curing.

According to a further aspect, an adhesive connection according to claim 7 is disclosed. The adhesive connection of at least two joining parts has an adhesion promoting layer between the joining parts, wherein the adhesion promoting layer is a coating of the powder coating composition of claim 1. The coating is made by applying the powder coating composition onto one of the joining parts.

According to a first embodiment of the adhesive connection, a first part of the at least two joining parts is a print substrate and a second part of the at least two joining parts is a printing medium. The adhesion promoting layer advantageously improves the adhesion of the print medium on the coated print substrate. For example, the print substrate is a surface to be printed on by a screen-printing process, which surface is coated with the powder coating composition prior to application of the printing medium. A use of the powder coating composition in a printing process is disclosed.

According to a second embodiment of the adhesive connection, a first part of the at least two joining parts is a component surface and a second part of the at least two joining parts is a coating layer. The coating layer may be one of a corrosion protection coating, a varnish and an intumescent fire protecting coating. The adhesion promoting layer advantageously improves the adhesion of the coating layer on the coated component surface, wherein the component may be a metal structure. For example, the average particle size of the porous particles may be about 10 micrometers, with a maximum particle size of 30 micrometers, if a varnish is to be applied as a coating layer, to provide a smooth surface. If an intumescent fire protecting coating is to be applied, an average particle size of up to 200 micrometers may be used to provide improved adhesion when the intumescent fire protecting coating is activated by heat. The varnish may be water-based. The component may be one of a radiator, a door, a window, or a machine. A use of the powder coating composition in a coating process of a component surface is disclosed.

According to a third embodiment of the adhesive connection, a first part of the at least two joining parts is a component surface and a second part of the at least two joining parts is a sealant. The component may be a wall cladding or facade cladding. The adhesion of the sealant, for example of silicone, on the component surface is enhanced by the adhesion promoting layer provided as a coating on the component surface. A use of the powder coating composition for sealing a component surface is disclosed.

According to a fourth embodiment of the adhesive connection, an adhesive layer is provided between the joining parts. The adhesive layer can be provided on the adhesion promoting layer. The adhesion promoting layer can be applied on both the first and the joining part, wherein the adhesive layer can be provided between the two adhesion promoting layers on the joining parts. The adhesion between two rigid joining parts is enhanced, which is advantageous for adhesive connections, which are subject to high forces. For example, the first part of the at least two joining parts can be a component surface and a second part of the at least two joining parts can be a label, which is advantageously permanently fixed to the component. The component may be a pressure vessel, which has to be provided with a label containing the production and operational data. In a further example, the first part of the at least two joining parts can be a component surface and the second part of the at least two joining parts can be a weight, which is necessary for the component to operate within given parameters. The component may be a wheel for a vehicle or any other rotating part, wherein the weight may be a balancing weight. A use of the powder coating composition for forming an adhesive connection of two rigid components is disclosed.

According to a further aspect, a process for the production of a powder coating composition according to claim 15 is disclosed. In the process, the at least one binding agent and the at least one hardening agent, and as optional components the pigments, the filler and the additives are processed in an extruder, wherein an extrudate obtained in this way is ground, and wherein the porous particles are subsequently blended in or bonded to nonporous particles of the ground mixture. A powder coating composition produced by the process is disclosed.

Without further elaboration, it is believed that one skilled in the art can, using the preceding description, utilize the aspects of the disclosure to its full extent. The following exemplary embodiment is therefore to be construed as merely illustrative. In the foregoing and in the following example, all temperatures are set forth uncorrected in degrees Celsius, and, unless otherwise indicated, all parts and percentages are by weight.

### EXAMPLE

The exemplary powder coating composition for promoting adhesion may be used for coating a substrate with high decorative requirements. The powder coating composition comprises a basic formulation for one of the group of epoxy-polyester, polyester/polyurethane and epoxy base, the basic formulation consisting of binding and hardening agents: 40-98%, levelling agent: 0.2-1.0%, degassing agent: 0.2-1.5%, pigments: 0-30%, and filler: 0-40%.

The basic formulation is extruded and subsequently ground. The exemplary powder coating composition is subsequently obtained by bonding the porous particles, for example of diatomaceous earth, into the first basic formulation in a bonding mixer, the resulting powder coating composition consisting of the basic formulation: 94.00% and diatomaceous earth: 6.00%.

An average particle size of one micrometer to ten micrometer and a maximum particle size of 20 micrometers to 30 micrometers advantageously provide a smooth surface of the coating with high decorative requirements.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows an embodiment of an adhesive connection in a schematic illustration;

FIG. 2 shows a further embodiment of an adhesive connection in a schematic illustration; and

FIG. 3 shows an exemplary embodiment of an adhesive connection according to FIG. 2.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

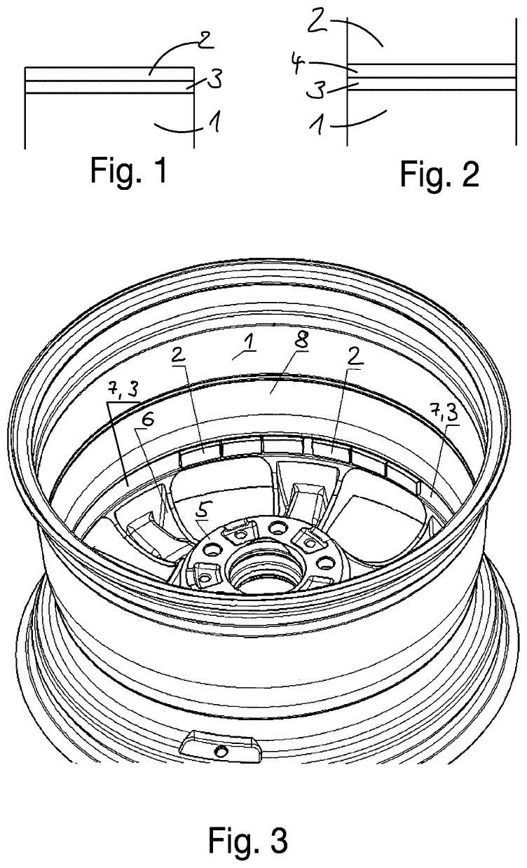

In FIG. 1, an embodiment of an adhesive connection is schematically depicted. The adhesive connection of two joining parts 1, 2 has an adhesion promoting layer 3 between the joining parts 1, 2, wherein the adhesion promoting layer 3 is a coating of a powder coating composition, which consists of an extruded and subsequently ground mixture of binding agents, hardening agents and optionally one or more of pigments, filler and additives, and porous particles of a mesoporous or microporous material in a proportion of one to twelve percent by weight of the pow-der coating composition. The porous particles have an average particle size of 5 micrometers to 200 micrometers. For example, the first part 1 of the at least two joining parts is a print substrate and the second part 2 is a printing medium, or the first part 1 is a component surface and the second part 2 is a coating layer, or the first part 1 is a component surface and the second part 2 is a sealant.

In FIG. 2, a further embodiment of an adhesive connection is schematically depicted. The adhesive connection of the two joining parts 1, 2 has the adhesion promoting layer 3 of FIG. 1 between the joining parts 1, 2, wherein further an adhesive layer 4 is provided between the joining parts 1, 2. Furthermore, the adhesive layer 4 could be provided between two adhesion promoting layers 3, which is not depicted. For example, the first part 1 is a component surface, may be of a pressure vessel, and the second part 2 is a label, or the first part 1 is a component surface of a wheel and the second part 2 is a balancing weight.

In FIG. 3, an exemplary embodiment of the adhesive connection according to FIG. 2 is shown. A light alloy wheel is the first joining part 1, which is depicted from its inner side. It consists of a wheel disc 5, spokes 6 and a rim 8. As two second joining parts 2, two balance weights are attached to a bonding surface 7, which is coated with the adhesion promoting layer 3. While the complete bonding surface 7 may be coated with the adhesion promoting layer 3, the adhesive layer 4 is provided only between the balance weights 2 and the bonding surface 7.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A powder coating composition for promoting adhesion, the powder coating composition consisting of:
an extruded and subsequently ground mixture of at least one binding agent, at least one hardening agent and optionally one or more of pigments, filler and additives; and
porous particles of a mesoporous or microporous material in a proportion of one to twelve percent by weight of the powder coating composition;
wherein the porous particles have an average particle size between one micrometer and 200 micrometers.

2. The powder coating composition according to claim 1, wherein the porous particles have an average particle size between one micrometer and 50 micrometers.

3. The powder coating composition according to claim 1, wherein the porous particles have an average particle size of one micrometer to ten micrometers and a maximum particle size between 20 micrometers and 30 micrometers.

4. The powder coating composition according to claim 1, wherein the porous particles are blended into the previously ground mixture.

5. The powder coating composition according to claim 1, wherein the porous particles are bonded to nonporous particles of the previously ground mixture.

6. The powder coating composition according to claim 1, wherein the porous particles are of diatomaceous earth or another natural or synthetic microporous material, such as a zeolite or active alumina.

7. An adhesive connection of at least two joining parts having an adhesion promoting layer between the joining parts, wherein the adhesion promoting layer is a coating of the powder coating composition of claim 1.

8. The adhesive connection according to claim 7, wherein a first part of the at least two joining parts is a print substrate and a second part of the at least two joining parts is a printing medium.

9. The adhesive connection according to claim 7, wherein a first part of the at least two joining parts is a component surface and a second part of the at least two joining parts is a coating layer.

10. The adhesive connection according to claim 9, wherein the coating layer is one of a corrosion protection coating, a varnish and an intumescent fire protecting coating.

11. The adhesive connection according to claim 7, wherein a first part of the at least two joining parts is a component surface and a second part of the at least two joining parts is a sealant.

12. The adhesive connection according to claim 7, wherein an adhesive layer is provided between the joining parts.

13. The adhesive connection according to claim 12, wherein a first part of the at least two joining parts is a component surface and a second part of the at least two joining parts is a label.

14. The adhesive connection according to claim 12, wherein a first part of the at least two joining parts is a component surface and a second part of the at least two joining parts is a weight.

15. A process for producing a powder coating composition according to claim 1, wherein the at least one binding agent and the at least one hardening agent, and as optional components the pigments, the filler and the additives are processed in an extruder, wherein an extrudate obtained in this way is ground, and wherein the porous particles are subsequently blended in or bonded to nonporous particles of the ground mixture.
